(19) United States
(12) Patent Application Publication
(10) Pub. No.: US 2010/0014378 A1
(43) Pub. Date: Jan. 21, 2010

(54) MIXING AND/OR TURBULENT MIXING DEVICE AND METHOD

(76) Inventor: Lueder Strahmann, Barnstorf (DE)

Correspondence Address: BROOKS KUSHMAN P.C., 1000 TOWN CENTER, TWENTY-SECOND FLOOR, SOUTHFIELD, MI, 48075, US

(21) Appl. No.: 11/722,369

(22) PCT Filed: Dec. 20, 2005
(86) PCT No.: PCT/DE05/02292

§ 371 Date: Jun. 21, 2007

(30) Foreign Application Priority Data
Dec. 22, 2004 (DE) 202004019745.6

(51) Int. Cl. B01F 5/06

(52) U.S. Cl. 366/165.5

(57) ABSTRACT

Previous devices and methods offer solutions for mixing and/or turbulent mixing tasks. Said solutions are lacking in the implementation and/or optimization of important factors such as mixing and turbulent mixing intensity and/or natural liquid, vapor and gas-specific mixing and turbulent mixing and/or cost-efficient application possibilities and/or precise controllability of numerous substances and amounts. The aim of the invention is to better combine or optimize said factors. Through-flow plates (2,3) which are provided with special hole arrangements and matching mixing and/or turbulent mixing aids such as funnels (4) enable better control, regulation and optimization of flow speeds, mixing and/or turbulent mixing intensities and combinations and complex mixing and/or turbulent mixing processes. The invention is suitable for efficient mixing and/or turbulent mixing of liquids and/or mixtures of liquids and solids and/or vapors and/or gases. Many applications are conceivable, e.g. in water treatment, the food and beverages industry, medicine, pharmaceuticals, biology, physics and chemistry.

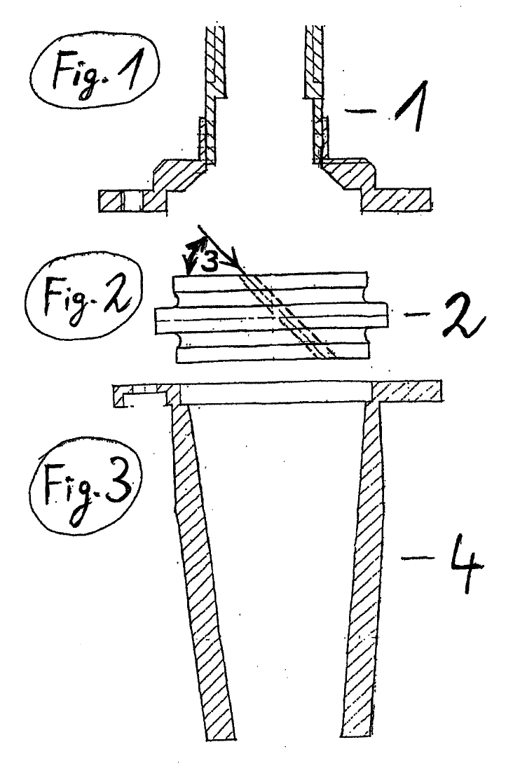

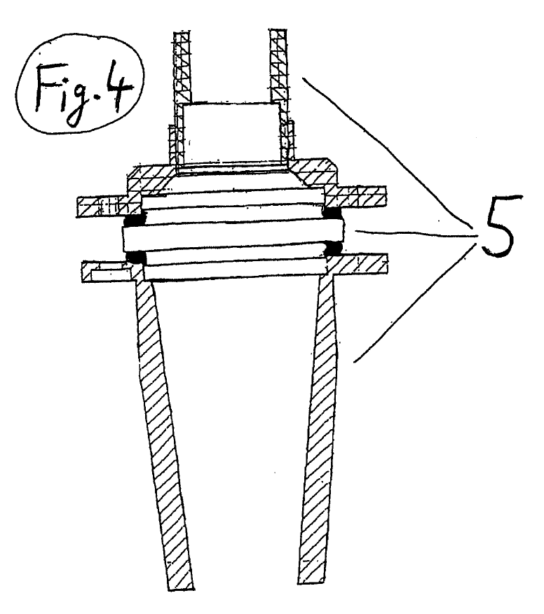

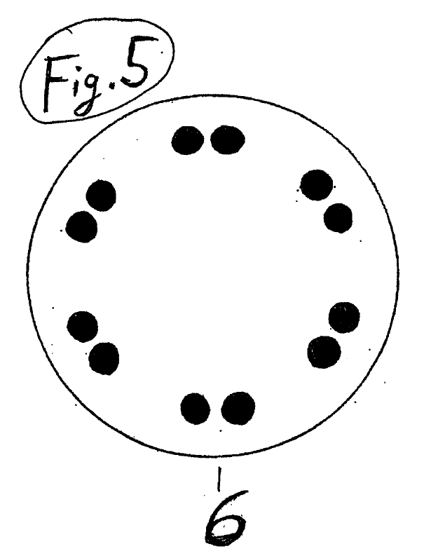

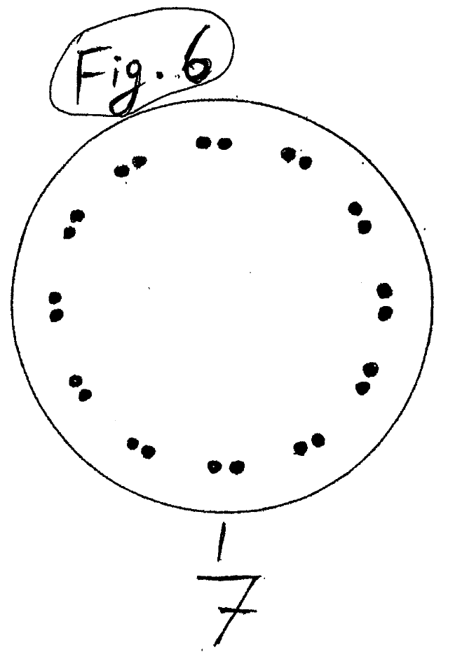

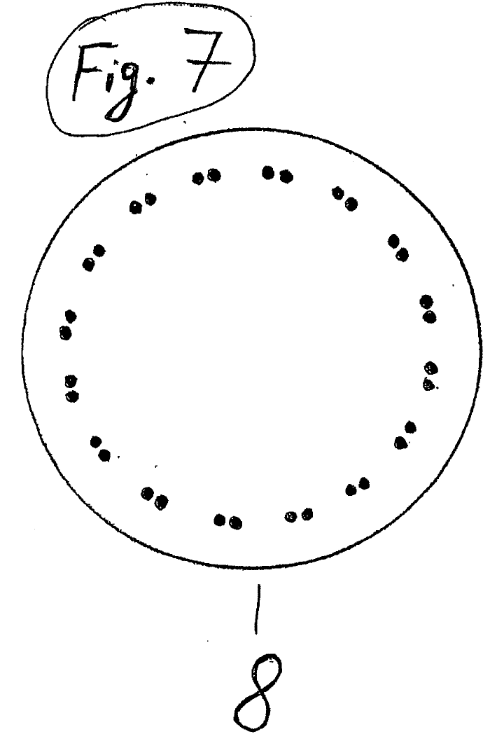

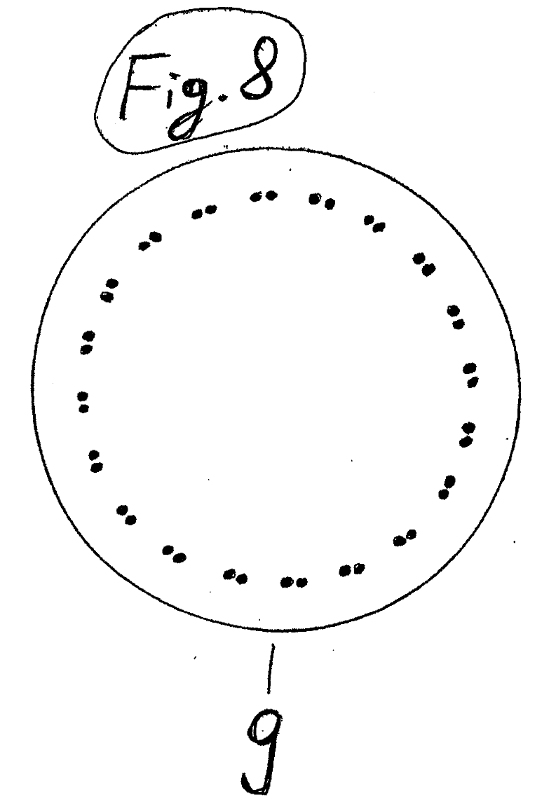

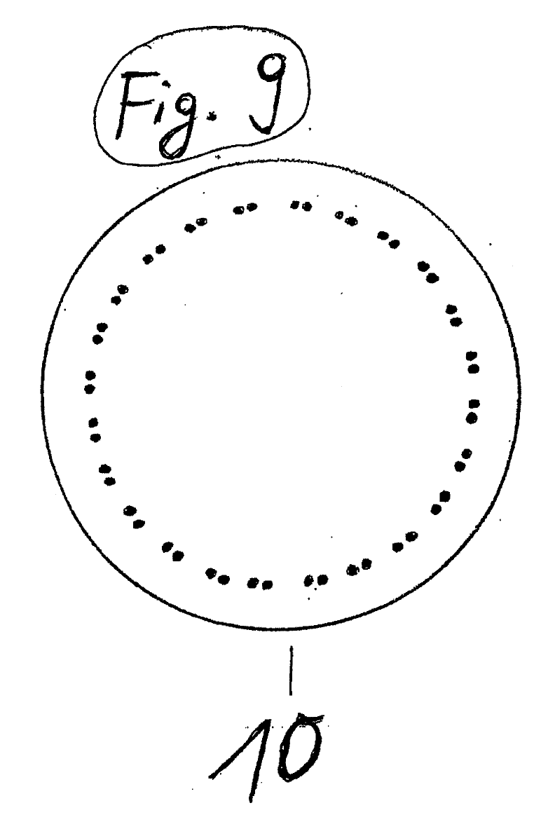

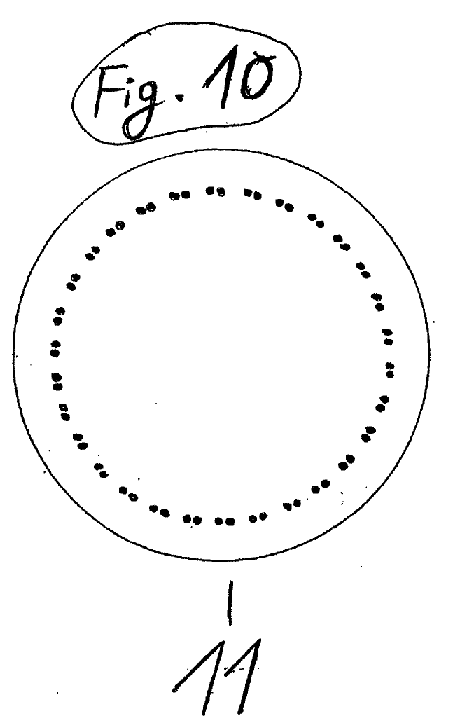

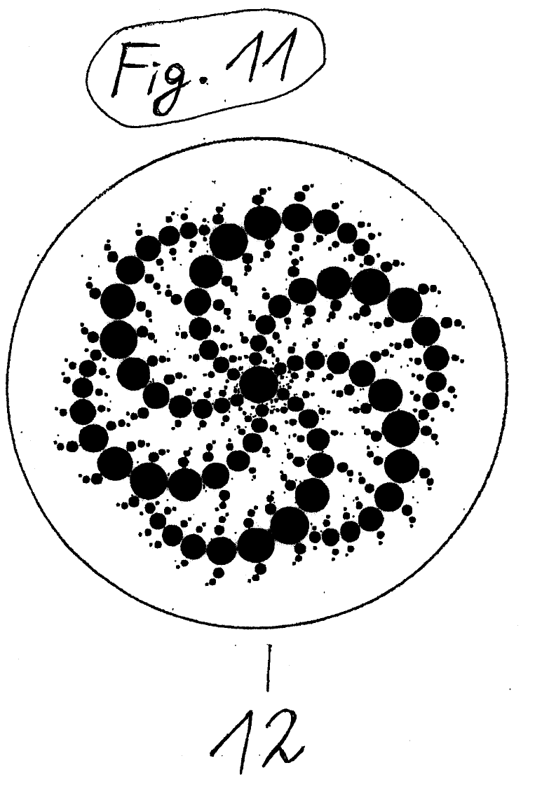

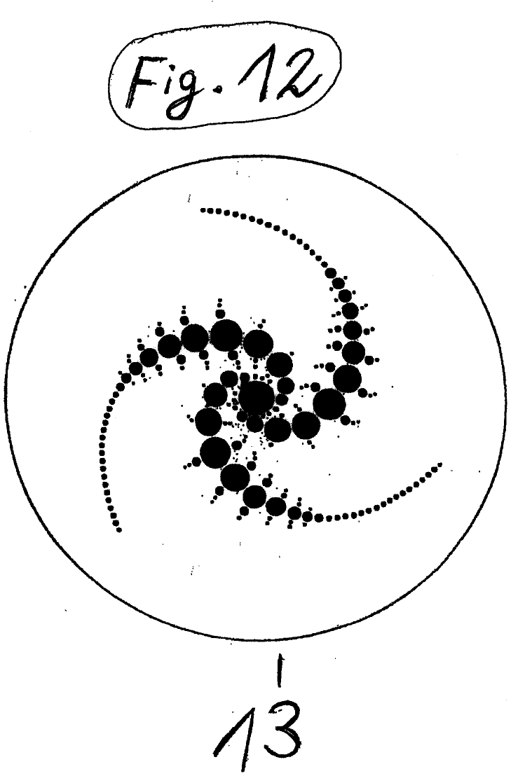

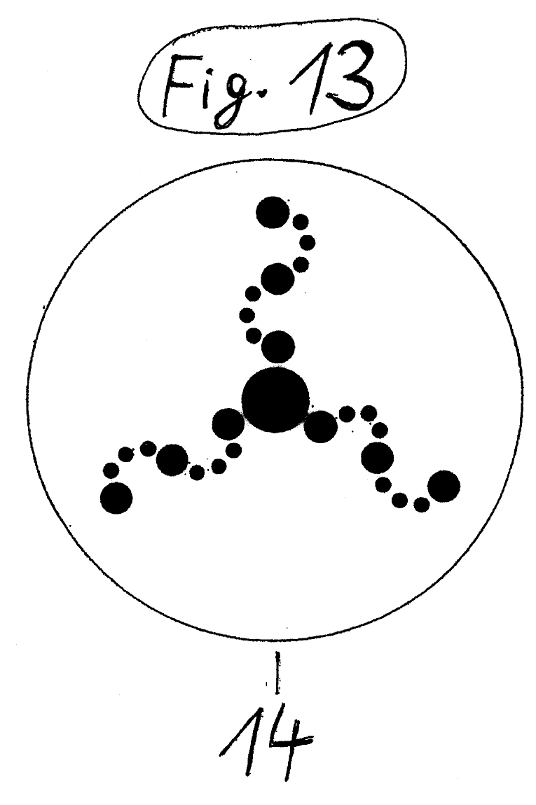

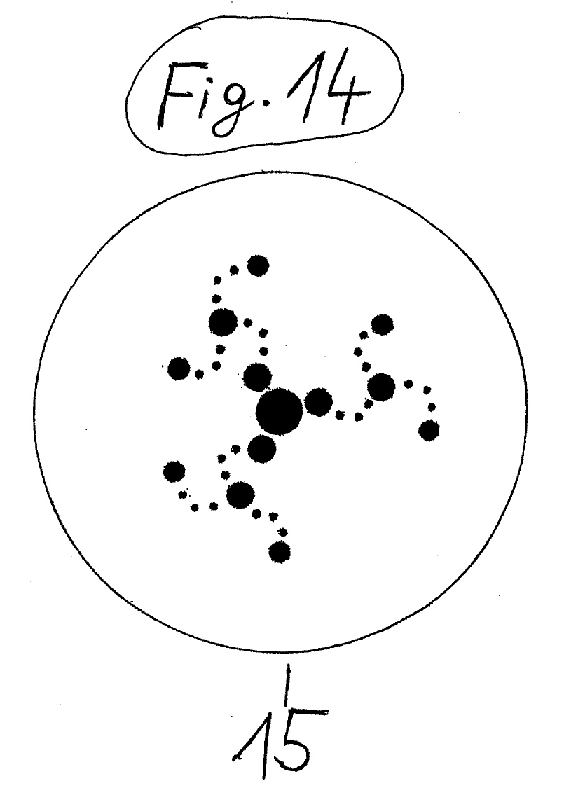

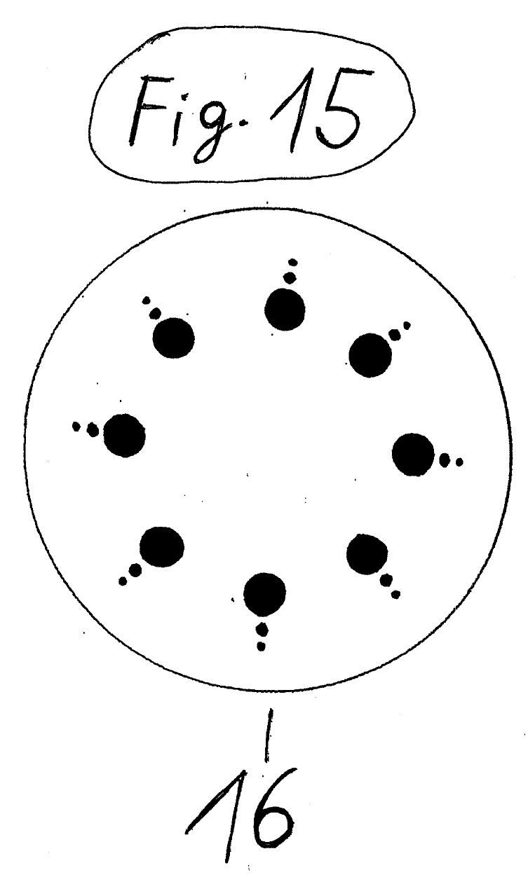

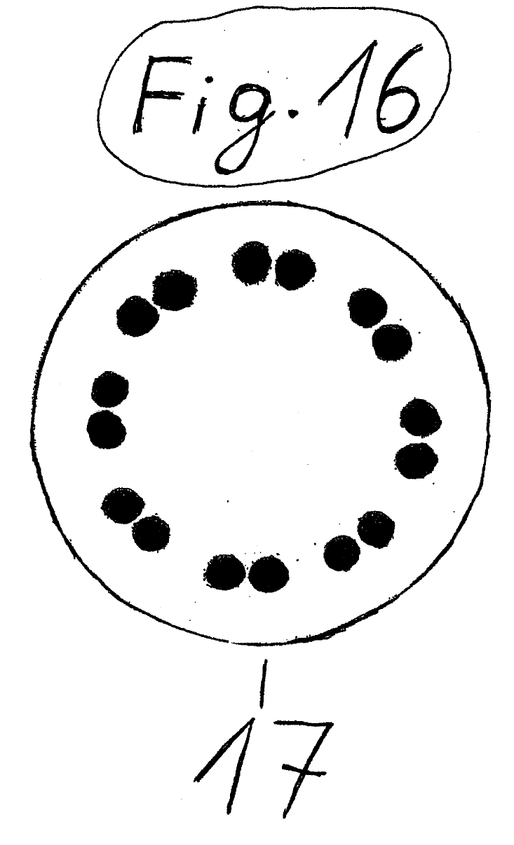

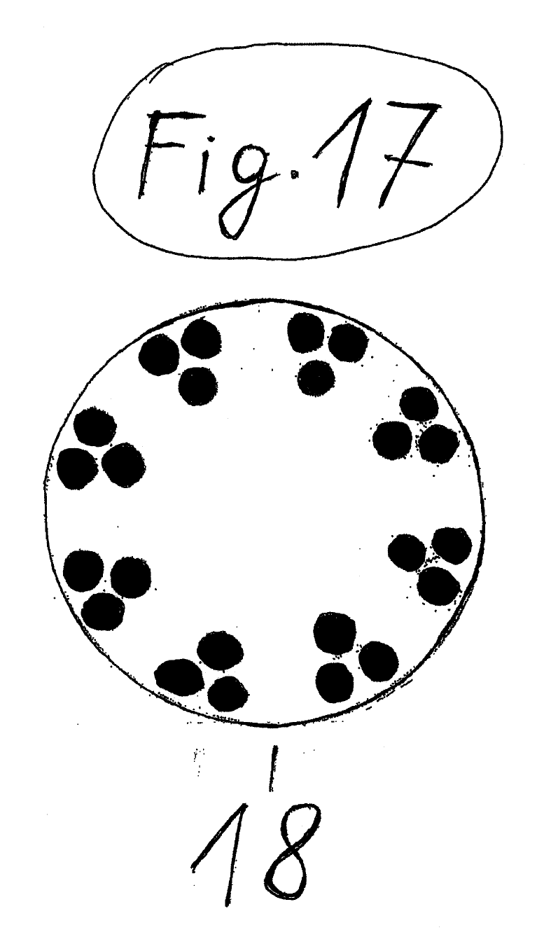

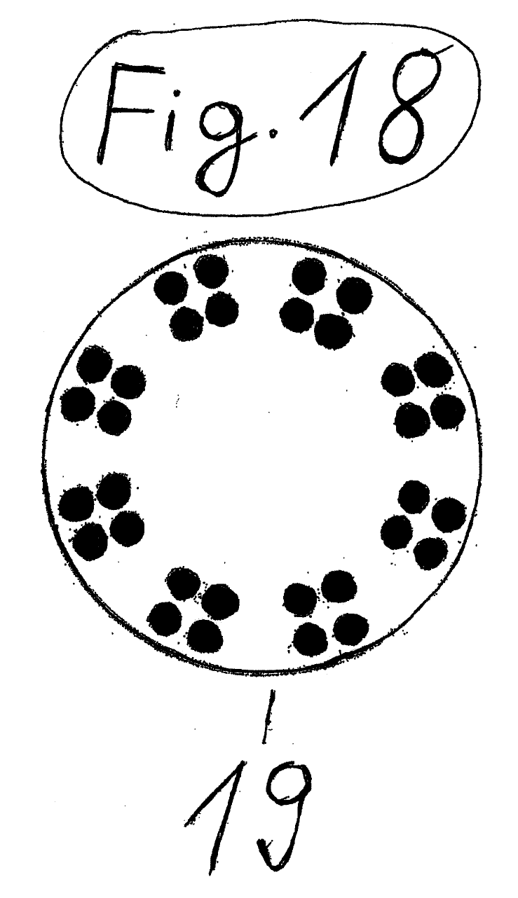

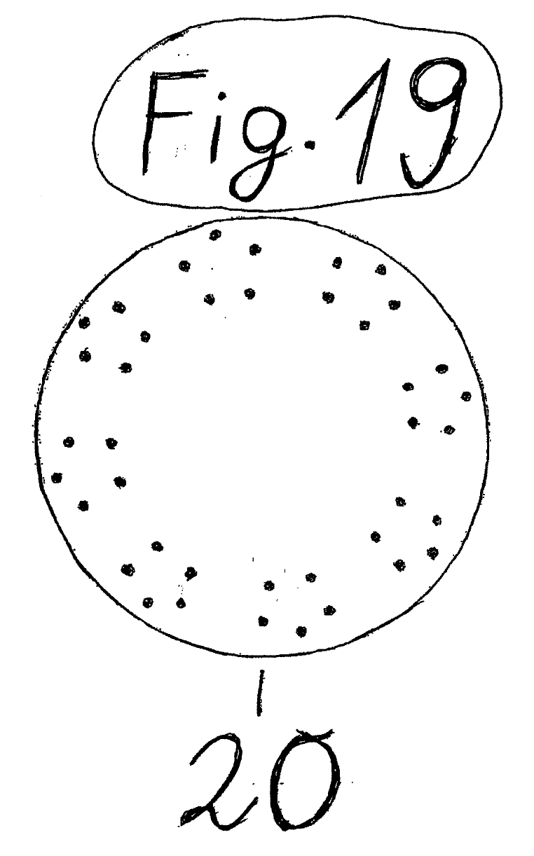

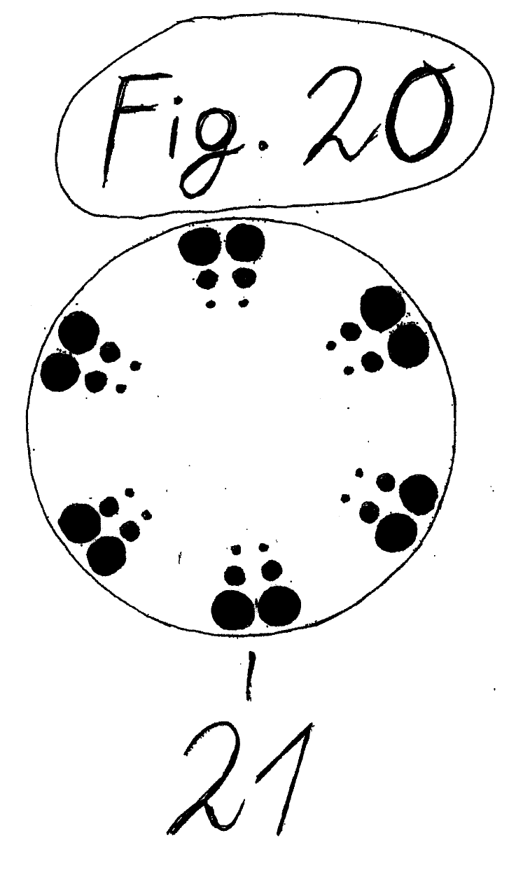

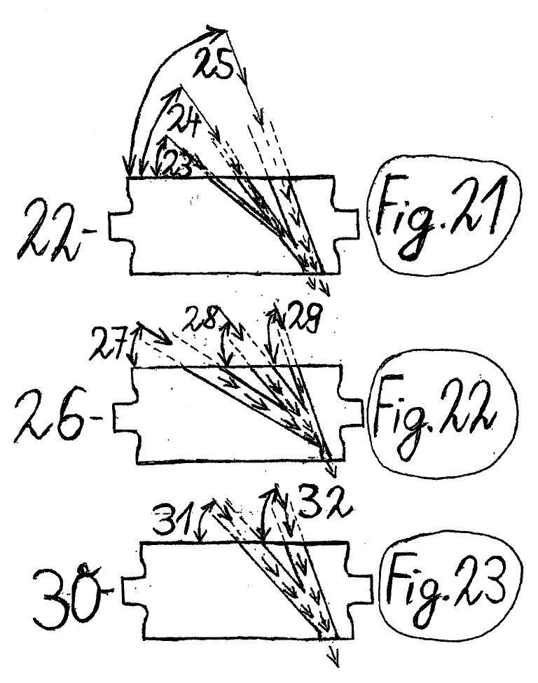

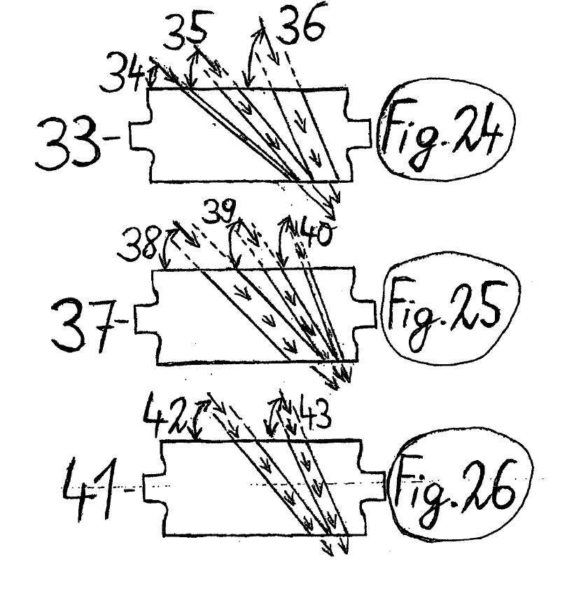

The invention relates to a mixer and/or swirler (5) and mixing and/or swirling methods for mixing and/or swirling liquids and/or liquid-solid mixtures and/or vapors and/or gases, characterized by one (2) or more through-flow plates that are respectively provided with at least three obliquely arranged and uniformly distributed holes, and additionally characterized by mixing and/or swirling supporters that exhibit, for example, funnel-like shapes (4) and/or cylindrical shapes and/or sphere-like shapes and/or bell-like shapes and/or shapes with corners and/or different mixed geometric shapes, and are tuned to the respective throughflow plates such that desired mixing and/or swirling outflows, effects and results are attained.

Terms such as “living water”, “energetic water”, “excited water” or “vital water” have been gaining currency for quite some time in water research and technical water literature, particularly because of the studies and experiments of Viktor Shauberger, the water scientist and naturalist. What is meant thereby is that in addition to chemical and biological qualities good water should also, above all, have a good physical quality. Observations of nature show that water and movement are very often inseperably connected. When water is observed in its natural surroundings, it generally moves in one way or another. Even in bodies of standing water, water movements are constantly being formed between various water layers owing to changing temperatures and water densities. Water swirling is a particularly intensive movement of water. Water swirlings and the processes occurring therewith are ever more frequently being seen as an efficient method in nature for exciting or releasing the self-cleaning forces of the water, and for improving the energetic state of water. An improvement of the energies, vibrations and information present in water is spoken of in this context. It is assumed that the internal structure of water, the so-called cluster structure, varies. What is understood by this is accumulations of water molecules physically attached to one another. Water molecules have this particular property that they can be charged to be slightly positive at one site and slightly negative at another site. The water molecules attract one another mutually as a result. Relatively large clusters or “molecular heaps” are assumed to have formed in the case of water that is referred to as being less alive. In the case of intensive water movements such as those of swirling, some researchers assume that relatively large clusters are subdivided or disintegrate into ever smaller clusters. According to these approaches to the explanation, the water would thereby achieve a so-called finely divided state and could possibly more easily be absorbed and/or used by biological organisms such as plants, animals and humans. Furthermore, some researchers assume that in natural swirling occurring freely in nature water can be enriched in a balanced ratio with components of light and air and novel energies at fine material levels by torsional forces produced during swirling and the particular nature of dipolar water molecule structures, which react in a particular way to water movements. These theories are under controversial discussion. However, it may be observed that nature forms swirlings of water and air as well as a wide spectrum of swirlings of other mixtures of liquid, vapor and gas, doing so comprehensively, in large dimensions and in innumerable variations. No matter how individual theories are judged, there seem to be good grounds for the fact that nature does behave in this way. For example, the taste and appearance of water can be improved by swirling it in a natural way. Water can be enriched with oxygen in a natural manner. It may be observed that water swirled while cool remains cool over a lengthy period even if the temperature of the air surrounding the water is very much higher, in a way similar to that observed from nature, for example from observing the water of mountain streams or mountain lakes in high summer. It also seems to be possible to extend the natural keeping quality of water by swirling it. Depending on application, it is possible in each case to construct the invention presented here with the aid of differently designed throughflow plates to which mixing and/or swirling supporters are tuned such that mixing and/or swirling sequences and processes occurring in nature can be imitated in a fashion as close to nature as possible, but nevertheless at very efficient intensities and modes of expression. It is possible thereby for processes, effects and results that take up much more time in nature to be effectively simulated in shorter processes.

Various mixers and/or swirlers and mixing and/or swirling methods have already attempted to render swirling processes useful. The invention presented makes simultaneous use of a number of functional mechanisms in order to improve the qualities of liquids and/or air and/or vapors and/or gases in a way that is as effective as possible but nevertheless close to nature. The Japanese water researcher Masaru Emoto reports in his books about water that water is an extremely sensitive and sentient medium that can even react in an astonishing way to human emotions and to sounds. The invention described here attempts to take account of such phenomena and observations. Since the mixer and/or swirler comes into intensive contact with vapors and/or gases and/or liquid-solid mixtures and/or liquids such as, for example, water, it is assumed that the invention presented here also itself becomes a transmitter of vibrations and information to the medium that is to be mixed and/or swirled. The invention is therefore energetically cleaned by various processes, techniques and methods, and is excited so as to build up and gain as far as possible energies and vibrations that are useful for vapors and/or gases and/or liquid-solid mixtures and/or liquids such as, for example, water, in order to offer the liquids and/or liquid-solid mixtures and/or vapors and/or gases an environment that is as advantageous and close to nature as possible.

Once liquids and/or liquid-solid mixtures and/or vapors and/or gases have flowed into the mixture and/or swirler, they strike the throughflow plate, which has been provided in a specific way with holes. Owing to the possible use of various throughflow plates, it is possible to vary the mixing and/or swirling sequences so as to be able to attain very different effects and results. Although the various throughflow plates differ from one another, the design of the stamped holes and/or hole formations on these throughflow plates exhibit the following features:
All the holes and/or hole formations applied to a throughflow plate are arranged there in the same direction of hole rotation, clockwise in a dextrorotatory fashion, or counterclockwise in a levorotatory fashion.
The holes and/or hole formations arranged in the same direction of hole rotation either are all applied with the same angular size to a throughflow plate, or the holes lie on a throughflow plate in specific arrangements at different angles so as to produce at these sites additional local mixings and/or swirlings within the total mixing and/or total swirling.
The holes and/or hole formations are distributed symmetrically and/or uniformly on a throughflow plate. This is required so as to be able to produce swirls that are ordered and/or close to nature and/or intensive.

After liquids and/or liquid-solid mixtures and/or vapors and/or gases flow out from a throughflow plate, they strike a mixing and/or swirling supporter, a further control element of the mixing and/or swirling. Mixing and/or swirling supporters can be, for example, conical or hyperbolic funnels. If use is made of such funnels, for example, liquids such as water form intensive swirls prepared by throughflow plates. A liquid such as water then leaves the funnel in an intrinsically spiral flow or in a swirl, and forms outside the mixer and/or swirler a liquid bell intrinsically flowing in a spiral or swirling. The size and swirling intensity (intensively dextro-swirling or intensively levo-swirling) of this bell that has been produced empirically play a role in quality improvements resulting for the liquids produced. So that, for example, a large and intensively swirling water bell can result at a customary domestic water connection with a normal quantity of water outflow, the funnel must correspond as well as possible to respective throughflow plates. It is also likewise possible to use mixing and/or swirling supporters that can function inside closed line system structures. Various mixing and/or swirling supporter systems and methods are capable of functioning, depending on the throughflow plates used, and depending on liquids and/or liquid-solid mixtures and/or vapors and/or gases, and depending on desired effects and results. Accurate design and adaptation of the respective throughflow plates to specific liquids and/or liquid-solid mixtures and/or vapors and/or gases, and to respective mixing and/or swirling supporters require experience and knowledge of the production of the respective mixing and/or swirling sequences and structures. This requires analyses and, frequently, many experiments. The mixing and/or swirling sequences react very sensitively to small variations in the various individual factors. A corresponding overall effect or overall result, for example perceptible and clear improvements in the quality of liquids and/or liquid-solid mixtures and/or vapors and/or gases can be expected and achieved only given appropriate adaptation of the individual factors, and a successful interplay between all the factors (synergy effects). Many applications of the invention are possible and can be conceived for improving liquids and/or liquid-solid mixtures and/or vapors and/or gases. Water preparation has been addressed. Improving wines, beers and juices, chiefly including taste, seems to be obvious. It could emerge that even improvements in blood quality could be possible by means of such a method, because it is assumed that blood also forms many kinds of swirlings in the body. In the event of steaming, it would be possible to think of an application in saunas, in which case water vapors in saunas could be sucked up and would then be led through the mixer and/or swirler in order to release them again in strongly swirling movements. The experience and effects of saunas can thereby be improved. Similar possibilities are thereby opened up for mixtures of air and other gases for example in conjunction with air conditioning systems and other ventilation systems.

The mixer and/or swirler and mixing and/or swirling methods are/is likewise suitable for mixing various substances intensively and cost effectively. To this end, the substances to be mixed are led into the individual holes of the throughflow plate, these being, in turn, liquids and/or liquid-solid mixtures and/or vapors and/or gases. The flow rates can be controlled by selecting the hole sizes and the quantity of the substance introduced. The exit points from a throughflow plate can likewise be defined exactly. If the aim is to intermix two substances, the substance A is, for example, led into a throughflow hole A, and the substance B is led into a throughflow hole B. The exit points of throughflow hole A and throughflow hole B would then be placed near one another so as to result in local mixing and/or swirling. If it is intended to mix only two substances, the same principle is repeated many times on a throughflow plate, thus achieving many local mixings and/or swirlings of the two substances, as well as mixing and/or swirling of the many individual local mixings and/or swirlings one among another and one in another in a large overall mixing and/or overall swirling. The two substances have thereby been mixed and/or swirled with one another in an intensive and cost efficient way. A further advantage of such a mixing and/or swirling method is that it is possible to carry out very complex mixing and/or swirling sequences with numerous substances, it being possible both for the dosages and for the exit points of individual substances to be accurately controlled. If, for example, the aim is firstly to intermix and/or interswirl two gases and, in parallel therewith, to intermix and/or interswirl two liquids, in order then, in turn, to intermix the gas mixture and the liquid mixture, it is possible for the mixing and/or swirling sequence(s) to be accurately controlled by an efficient arrangement of the substances to be introduced into a throughflow plate, and by defining the corresponding exit points of the respective substances, and by defining the respective quantities and hole sizes as well as the suitable mixing and/or swirling supporter(s). In this example, the exit points of the gases would be placed next to one another, and the exit points of the liquids would likewise be placed next to one another. This would then result initially in local mixings and/or swirlings of the gases among one another, and of the liquids among one another. The gas mixture would then, in turn, mix and/or swirl with the liquid mixture in the overall mixing and/or overall swirling. An intensive overall mixing is achieved in one operation, whereas in the case of other apparatuses and methods this would require a number of operational steps, more expenditure of energy and more outlay on space. It is also possible not even to let the substances flow out at first from a throughflow plate, but to let the individual throughflow holes to go over into one another already inside a throughflow plate such that local mixings and/or swirlings already result before the substances leave the throughflow plate. Numerous variations are on offer as to how such sequences can be controlled. The precise design of such an application requires accurate plans, analyses and experiments. Numerous applications of this method are possible, for example in technical and scientific methods, in chemistry, biology, pharmaceutics, medicine or in the drinks and food sector.

### LIST OF REFERENCE NUMERALS

1 Head piece side view
2 Throughflow plate side view
3 Angular position of a hole
4 Conical funnel side view
5 Screwed together mixer and/or swirler
6 12-hole throughflow plate
7 24-hole throughflow plate
8 32-hole throughflow plate
9 40-hole throughflow plate
10 48-hole throughflow plate
11 60-hole throughflow plate
12 6-element wheel as 409-hole throughflow plate
13 3-member spiral as 196-hole throughflow plate
14 3-element formation as 28-hole throughflow plate
15 3-element formation as 40-hole throughflow plate
16 8-element formation as 24-hole throughflow plate
17 16-hole throughflow plate
18 8 three-hole formations as 24-hole throughflow plate
19 8 four-hole formation as 32-hole throughflow plate
20 8 five-hole formations as 40-hole throughflow plate
21 12 three-hole formations, pairwise arranged as 36-hole throughflow plate
22 Cross section of throughflow plate with specific hole sizes and hole angular positions
23 Relatively small hole angle
24 Medium sized hole angle
25 Relatively large hole angle
26 Cross section of throughflow plate with specific hole sizes and hole angular positions
27 Relatively small hole angle
28 Medium sized hole angle
29 Relatively large hole angle
30 Cross section of throughflow plate with specific hole sizes and hole angular positions
31 Relatively small hole angle
32 Relatively large hole angle
33 Cross section of throughflow plate with specific hole sizes and hole angular positions
34 Relatively small hole angle
35 Medium sized hole angle
36 Relatively large hole angle
37 Cross section of throughflow plate with specific hole sizes and hole angular positions
38 Relatively small hole angle
39 Medium sized hole angle
40 Relatively large hole angle
41 Cross section of throughflow plate with specific hole sizes and hole angular positions
42 Relatively small angle
43 Relatively large angle

1. A mixer and/or swirler for mixing and/or swirling liquids and/or liquid-solid mixtures and/or vapors and/or gases, comprising a mixing and/or swirling supporter and at least one throughflow plate which is provided in each case with at least three identical hole formations, arranged singly or pairwise and distributed in a circular, uniform positional arrangement on the throughflow plate and having at least two holes, the spaces between the singly arranged hole formation or the pairwise arranged hole formations on the throughflow plate being respectively of identical size.

2. The mixer and/or swirler as claimed in claim 1, characterized in that the mixing and/or swirling supporter(s) has/have a conical shape.

3. The mixer and/or swirler as claimed in claim 1, characterized in that the mixing and/or swirling supporter(s) has/have a hyperbolic shape.

4. The mixer and/or swirler as claimed in claim 1, characterized in that the mixing and/or swirling supporter(s) has/have a spherical shape.

5. The mixer and/or swirler as claimed in claim 1, characterized in that the at least one throughflow plate is provided with six identical hole formations that are respectively distributed in a circle and uniformly on the throughflow plate and respectively consist of hole pairs.

6. The mixer and/or swirler as claimed in claim 1, characterized in that the at least one throughflow plate is provided with twelve identical hole formations that are respectively distributed in a circle and uniformly on the throughflow plate and respectively consist of hole pairs.

7. The mixer and/or swirler as claimed in claim 1, characterized in that the at least one throughflow plate is provided with sixteen identical hole formations that are respectively distributed in a circle and uniformly on the throughflow plate and respectively consist of hole pairs.

8. The mixer and/or swirler as claimed in claim 1, characterized in that the at least one throughflow plate is provided with twenty identical hole formations that are respectively distributed in a circle and uniformly on the throughflow plate and respectively consist of hole pairs.

9. The mixer and/or swirler as claimed in claim 1, characterized in that the at least one throughflow plate is provided with twenty-four identical hole formations that are respectively distributed in a circle and uniformly on the throughflow plate and respectively consist of hole pairs.

10. The mixer and/or swirler as claimed in claim 1, characterized in that the at least one throughflow plate is provided with thirty identical hole formations that are respectively distributed in a circle and uniformly on the throughflow plate and respectively consist of hole pairs.

11. The mixer and/or swirler as claimed in claim 1, characterized in that the at least one throughflow plate is provided with eight identical hole formations that are respectively distributed in a circle and uniformly on the throughflow plate and respectively consist of three holes of different sizes.

12. The mixer and/or swirler as claimed in claim 1, characterized in that the at least one throughflow plate is provided with eight identical hole formations that are respectively distributed in a circle and uniformly on the throughflow plate and respectively consist of hole pairs.

13. The mixer and/or swirler as claimed in claim 1, characterized in that the at least one throughflow plate is provided with eight identical hole formations that are respectively distributed in a circle and uniformly on the throughflow plate and respectively consist of three holes of identical size.

14. The mixer and/or swirler as claimed in claim 1, characterized in that the at least one throughflow plate is provided with eight identical hole formations that are respectively distributed in a circle and uniformly on the throughflow plate and respectively consist of four holes of identical size.

15. The mixer and/or swirler as claimed in claim 1, characterized in that the at least one throughflow plate is provided with eight identical hole formations that are respectively distributed in a circle and uniformly on the throughflow plate and respectively consist of five holes of identical size which are arranged in a circle.

16. The mixer and/or swirler as claimed in claim 1, characterized in that the at least one throughflow plate is provided with twelve pairwise arranged hole formations, respectively consisting of three holes of different size per hole formation that are distributed in pairs in a circle and uniformly on the throughflow plate.

17. The mixer and/or swirler as claimed in claim 1, characterized in that the at least one throughflow plate is provided with twelve pairwise arranged hole formations, each hole formation consisting of three holes of different size that are distributed in pairs in a circle and uniformly on the throughflow plate, relatively small holes with relatively small angles opening inside the throughflow plate into medium sized holes, the medium sized holes with medium angles for their part likewise going over inside the throughflow plate into relatively large holes, and the relatively large holes having the largest angles.

18. The mixer and/or swirler as claimed in claim 1, characterized in that the at least one throughflow plate is provided with eight identical hole formations, the hole formations being distributed in a circle and uniformly on the throughflow plate and respectively consisting of three holes of different sizes, relatively large holes with relatively small angles opening inside the throughflow plate into the medium sized holes, the medium sized holes with medium angles for their part likewise going over inside the throughflow plate into relatively small holes, and the relatively small holes having the largest angles.

19. The mixer and/or swirler as claimed in claim 1, characterized in that the at least one throughflow plate is provided with eight identical hole formations, the hole formations being distributed in a circle and uniformly on the throughflow plate and respectively consisting of four holes of identical size, and holes lying nearer the middle of the throughflow plate and having relatively small angles open inside the throughflow plate into the holes lying nearer the edge of the throughflow plate and having relatively large angles.

20. The mixer and/or swirler as claimed in claim 1, characterized in that the at least one throughflow plate is provided with hole formations that respectively consist of holes interconnected inside the throughflow plate.

21. The mixer and/or swirler as claimed in claim 17, characterized in that the extensions of the relatively small holes with relatively small angles, of the medium sized holes with medium angles and of the relatively large holes with relatively large angles intersect outside the throughflow plate.

22. The mixer and/or swirler as claimed in claim 18, characterized in that the extensions of the relatively large holes with relatively small angles, of the medium sized holes with medium angles and of the relatively small holes with relatively large angles intersect outside the throughflow plate.

23. The mixer and/or swirler as claimed in claim 19, characterized in that the extensions of the holes, lying nearer the middle of the throughflow plate, with relatively small angles, and of the holes, lying nearer the edge of the throughflow plate, with relatively large angles intersect outside the throughflow plate.

24. The mixer and/or swirler as claimed in claim 1, characterized in that the at least one throughflow plate is provided with hole formations that respectively consist of holes intersecting outside the throughflow plate.
